(19) United States
(12) Patent Application Publication
(10) Pub. No.: US 2026/0175187 A1
(43) Pub. Date: Jun. 25, 2026

(54) METHOD OF PREVENTING METAL DUSTING IN A GAS HEATED REFORMING APPARATUS

(71) Applicant: Johnson Matthey Davy Technologies Limited, London (GB)

(72) Inventors: Mikael CARLSSON, Cleveland (GB); David DAVIS, Cleveland (GB); Roslyn KELSEY, Cleveland (GB); Mark Joseph MCKENNA, Cleveland (GB); Andrew Edward RICHARDSON, Cleveland (GB); Katharine SMART, Hertfordshire (GB); Benjamin SMITH, Cleveland (GB)

(21) Appl. No.: 18/871,016

(22) PCT Filed: Aug. 2, 2023
(86) PCT No.: PCT/GB2023/052043

§ 371 Date: Dec. 2, 2024

(30) Foreign Application Priority Data
Aug. 11, 2022 (GB) 2211765.9

(51) Int. Cl. B01J 8/04; B01J 8/06; C01B 3/384; C01B 3/40

(52) U.S. Cl. CPC B01J 8/0496; B01J 8/062; B01J 8/065; C01B 3/384; C01B 3/40

(57) ABSTRACT

The specification describes a gas heated reformer apparatus comprising: one or more tubes containing a steam reforming catalyst; and a shell surrounding said tube(s) and together with the tube(s) defining a shell side; wherein the shell comprises an inlet and outlet for a heat exchange medium; wherein the shell side is provided with a water gas shift catalyst located at one or more areas of the shell side where during use the heat exchange medium in contact with the shell side has a temperature of 500-750° C. Also described is a plant for producing hydrogen, ammonia or methanol comprising the gas heated reformer. A water gas shift catalyst can be retrofitted to an existing gas heater reformer.

### CROSS-REFERENCE TO RELATED APPLICATIONS

This application is the national stage entry of PCT/GB2023/052043, filed Aug. 2, 2023, which claims the benefit of priority to GB 2211765.9, filed Aug. 11, 2022, the entire contents of both of which are incorporated herein by reference.

### TECHNICAL FIELD

The invention relates to reforming of a hydrocarbon in a gas heated reformer, for example steam reforming of natural gas.

### BACKGROUND

In steam reforming a process gas comprising a mixture of a hydrocarbon feedstock and steam, and in some cases also carbon dioxide, is passed at an elevated pressure through catalyst-filled heat exchange tubes which are externally heated by means of a suitable heat exchange medium, generally a hot gas mixture. The heat exchange medium may be a combusting hydrocarbon fuel, a flue gas or the process gas that has passed through the tubes but which has then been subjected to further processing before being used as the heat exchange medium. For example GB 1 578 270 describes a process where a primary reformed gas is subjected to partial oxidation where it is partially combusted with oxygen or air and, in some cases is then passed through a secondary reforming catalyst bed (the process known as secondary reforming). The resultant partially combusted gas, by which term we include secondary reformed gas, is then used as the heat exchange medium, passed into the shell side of the primary reformer to heat the tubes. Where a secondary reformed gas is used as the heat-exchange medium, it normally contains methane, hydrogen, carbon oxides, steam and any gas, such as nitrogen, that is present in the feed and which is inert under the conditions employed. If flue gas is used as the heat exchange medium it typically contains large amounts of carbon oxides, steam and inert gasses.

Heat exchange reformers are typically fabricated from materials containing iron and nickel. Undesirable side reactions can occur under some conditions on the shell side of heat exchange reformer apparatus. These reactions are promoted by nickel and/or iron in the material, particularly on the heat exchange tubes. The undesirable side reactions include methanation and carburization reactions. These reactions result either directly or indirectly from a catalytic interaction between metals present in the material forming the shell side and carbon monoxide (CO) and/or methane present in the heat exchange medium. In steam reforming where the heat exchange medium in the primary reformer is the primary reformed gas that has been subjected to further processing, this problem is exacerbated by the desire, for economic reasons, to operate at low steam to hydrocarbon ratios, which results in increased reducing potential of the gas, as evidenced by the increased CO concentration.

Methanation is the conversion of carbon oxides to methane and water, i.e. in the case of CO methanation, the reverse of steam reforming and is promoted for example by nickel. The CO reaction is depicted below.

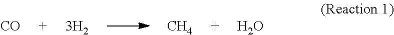

The water gas shift (WGS) reaction is the reaction of carbon monoxide with steam to produce carbon dioxide and hydrogen and is promoted for example by iron. The reaction is depicted below:

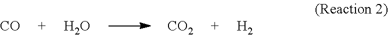

Carburization is believed to result from the interaction of carbon deposits with metals in the reactor tubes. The deposited carbon can result from CO reduction, CO disproportionation and hydrocarbon cracking reactions. These reactions occur on metal surfaces and may be catalysed by Fe, Ni or Cr. The carbon forming reactions are depicted below.

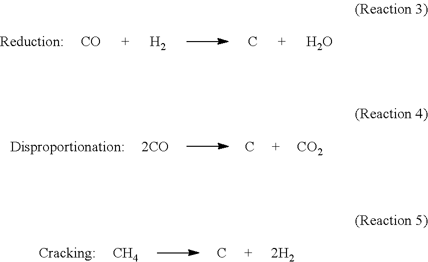

The carburization of materials is also known as ‘metal dusting’ and leads to corrosion of the metal surfaces, which may lead for example, to failure of the reformer tube. Increased levels of methane in the process gas may also arise via hydrogenation of the deposited carbon.

Because process efficiency and corrosion are effected by the carbon monoxide reactions it is desirable to reduce the interaction between carbon monoxide (CO) present in the heat exchange medium and metals on the shell side of reformer apparatus.

One approach to preventing corrosion of the shell side is to include an additive in the inlet gas. Examples of additives include a sulphur-containing compound (WO00/09441 (ICI)), a mixture of a sulphur-containing compound and a phosphorous-containing compound (WO01/66806 (Kalina)), or a compound containing at least one atom selected from phosphorous, tin, antimony, arsenic, lead, bismuth, copper, germanium, silver or gold (WO03/051771 (Johnson Matthey)). Another approach is to use corrosion-resistant materials on the shell side, as described for instance in H. J. Grabke, Research Disclosure, 37031, 1995/69. This approach however, is expensive and cannot be retrofitted to existing reactors.

Another approach to passivate a metal surface is by applying a coating. For instance, US2011/305605 (BASF) describes a process for protecting a metallic surface against chemical attacks at high temperatures by applying a layer forming composition, comprising a nanoscale powder, a porous ceramic powder and a solvent, to the metal surface to be protected, and allowing the layer forming composition to solidify. The resulting layer is porous with a very large inner surface, and can decompose impurities without the need for a catalyst.

Another approach is to use ceramic tubes in the reformer, as is described in WO2013/182425 (Casale).

There is a need for alternative ways for avoiding methanation and metal dusting on the shell side of a gas heated reformer. It would be ideal if a solution could be found which could be retrofitted to existing gas heated reformers without the need to entirely replace the tubes within the gas heated reformer.

### SUMMARY OF THE INVENTION

The present inventors have found that including a water gas shift (WGS) catalyst on the shell side of a gas heated reformer solves the problem above and also offers a number of other benefits. As used herein, the term “gas heated reformer” refers to an apparatus having one or more tubes with a shell surrounding said tube(s). The inner surface of the tube(s) define a tube side. The outer surface of the tube(s) and the inner surface of the shell together define a shell side. Gas heated reformers are sometimes referred to as heat exchange reformers in the literature.

As noted previously, metal dusting can be caused in part by decomposition of CO to carbon on the shell side (Reactions 3 and 4). These reactions can be reduced by including a WGS catalyst to promote the reaction between CO and steam on the shell side of the reformer via the WGS reaction (Reaction 2). If the gas has a positive thermodynamic driving force for water gas shift then the concentration of CO is decreased by the WGS catalyst and metal dusting is reduced or avoided. A further benefit is that because the WGS reaction is exothermic it can be used to help drive the endothermic steam reforming reactions taking place in the tubes of the gas heated reformer. While it is known to operate a water-gas shift unit downstream from a gas heated reformer, to the inventors' knowledge, including a WGS catalyst on the shell side of a reformer for the purposes of preventing metal dusting has not been considered previously.

GB2179366A describes a process for producing synthesis gas using an arrangement comprising a primary reactor which is an exchanger reactor and a secondary reformer; the effluent from the secondary reformer is passed to the primary reforming zone within the primary reactor as an indirect heating medium for the exchanger reactor. In a preferred embodiment a carbon monoxide shift catalyst is provided on the shell side of the exchange reactor. An advantage of using this arrangement is that, as the gas from the secondary reformer is cooled, Reaction 2 proceeds to the right hand side to maintain chemical equilibrium, thereby providing heat to the cooler end of the exchanger. This reference does not describe or appreciate the benefit of using appropriately located WGS catalyst to prevent metal dusting.

In a first aspect the invention relates to a gas heated reformer apparatus comprising: one or more tubes containing a steam reforming catalyst; and a shell surrounding said tubes and together with the tubes defining a shell side; wherein the shell comprises an inlet and outlet for a heat exchange medium; and wherein the shell side is provided with a water gas shift catalyst located at one or more areas of the shell side where during use the heat exchange medium in contact with the shell side has a temperature of 500-750° C.

The gas heated reformer may be a component of a plant for producing hydrogen, ammonia or methanol.

In a second aspect the invention relates to a plant for the production of hydrogen, ammonia or methanol, comprising a gas heated reformer according to the first aspect.

In a third aspect the invention relates to a process carried out in a gas heated reformer apparatus according to the first aspect, comprising the steps of:
providing a heat exchange medium comprising a synthesis gas to the inlet of the shell side; and carrying out water gas shift on the shell side.

In a fourth aspect the invention relates to a method of retrofitting a gas heated reformer apparatus, the apparatus comprising one or more tubes and a shell surrounding the tubes and together with the tubes defining a shell side, wherein the shell comprises an inlet and outlet for a heat exchange medium;
the method comprising the step of providing the shell side with a water gas shift catalyst located at one or more areas of the shell side where during use the heat exchange medium in contact with the shell side has a temperature of 500-750° C.

The retrofitted gas heated reformer is a reformer according to the first aspect.

In a fifth aspect the invention relates to the use of a water gas shift catalyst on the shell side of a gas heated reformer apparatus according to the first aspect, to prevent metal dusting.

### DETAILED DESCRIPTION OF THE INVENTION

Any sub-headings are included for convenience only and are not intended to limit the disclosure in any way.

### Gas Heated Reformer

In a conventional gas heated reformer apparatus a process fluid (typically a mixture comprising hydrocarbon and steam) is passed from a process fluid feed zone through heat exchange tubes containing a steam reforming catalyst. The heat exchange tubes (hereafter “tubes”) are disposed within a heat exchange zone defined by a shell through which a heat exchange medium is passed, and then into a process fluid off-take zone. A heat exchange medium flows through the shell around the outside of the heat exchange tubes. Heat exchange reformers of this type are described in GB1578270 (Pullman Inc) and WO97/05947 (ICI).

The “tube side” of such reformer apparatus shall be taken to include all the surfaces within the tubes of said apparatus. The volume defined by the tube side is referred to herein as the “tube side volume”. The tubes of the gas heated reformer contain a steam reforming catalyst. While the steam reforming catalyst may be included as a coating on the inner surface of the tubes, it is preferred that the catalyst is located within the tube side volume rather than as a coating on the inner surface of the tubes. For example, the tube side volume may include one or more catalyst beds comprising a steam reforming catalyst. Alternatively, the tube side volume may include one or more structures coated with a steam reforming catalyst. Such structured catalysts are described for instance in WO2012/103432 and WO2013/151885 (Johnson Matthey) and are available commercially as CATACEL™ technology from Johnson Matthey.

The “shell side” of such reformer apparatus shall be taken to include all the surfaces within the shell of said apparatus that are exposed to heat exchange medium. Such surfaces include the inner surface of the shell defining the heat exchange zone, the outer surfaces of the tubes, the outer surfaces of any fins attached to the tubes to increase their heat transfer area, the surfaces of any sheath tubes surrounding the heat exchange tubes, the surfaces of any tube-sheets defining the boundaries of said heat exchange zone and which are exposed to heat exchange medium and the outer surfaces of any header pipes within said heat exchange zone. The volume defined by the shell side is referred to herein as the “shell side volume”.

In the present invention the shell side is provided with a WGS catalyst located at one or more areas of the shell side where during use the heat exchange medium in contact with the shell side has a temperature of 500-750° C. A wide variety of WGS catalysts may be used in the present invention. The WGS catalyst should be chosen for its ability to promote the WGS reaction without promoting the methanation reaction. The WGS catalyst must be compatible with the temperature of the heat exchange medium at the areas of the shell side prone to metal dusting. Generally, areas prone to metal dusting are those areas where the temperature of the heat exchange medium is 500-750° C. Below 500° C. carbon formation reactions are kinetically slow. Above 750° C. carbon formation is thermodynamically disfavoured/impossible. The locations at which the heat exchange medium in contact with the shell side has a temperature of 500-750° C. can be determined in advance by simulations. Suitable WGS catalysts capable of operating at these conditions are variously referred to in the art as “high temperature shift” or “ultra high temperature shift” catalysts. A wide variety of WGS catalysts capable of operating at these temperatures are known in the art and the skilled person will be able to select suitable catalysts given the temperature and pressure of the heat exchange medium. In some embodiments the WGS catalyst is only located at areas of the shell side where during use the heat exchange medium in contact with the shell side has a temperature of 500-750° C. For the avoidance of doubt, the WGS catalyst may be located over all of the shell side surface which has a temperature of 500-750° C. during use, or only a portion thereof.

Examples of “high temperature” WGS catalysts which can be operated at temperatures of 400-750° C. are described in EP1149799A1 (Haldor Topsoe A/S), the contents of which are incorporated herein by reference. Suitable catalysts include those containing Mg, Mn, Al, Zr La, Ce, Pr and Nd being able to form basic oxides.

Examples of “ultra high” temperature shift catalysts which can be operated at temperatures of 450-900° C. are described in WO2010/135297A1 (Air Liquide), the contents of which are incorporated herein by reference. The catalyst is a partially reducible transition metal oxide such as oxides of cerium, neodymium, praseodymium, gadolinium and manganese.

Further examples of “ultra high” temperature shift catalysts which can be operated at temperatures of 450-900° C. are described in US2009/0232728A1 (Sud-Chemie Inc), the contents of which are incorporated herein by reference. The catalyst is rhenium deposited on a support having a surface area of 30 to 200 m²/g.

In a preferred embodiment the WGS catalyst is provided as a coating on the outer surface of the tubes. One benefit of this arrangement is that it can be retrofitted to existing gas heated reformer apparatus by applying a coating on the existing tubes, which may offer cost savings compared to fitting new tubes with a WGS catalyst coating. A further benefit of this arrangement is that the coating provides a physical barrier between the tube and the heat exchange medium, which also helps to prevent metal dusting. The coating may be a continuous coating or may be a partial coating over a portion of the outer surface of the tubes. To reduce unnecessary costs, the coating is preferably a partial coating located at the portion(s) of the shell side which are most susceptible to dusting, having regard to temperature and gas composition throughout the shell side.

Alternatively, instead of being applied as a coating on the outer surface of the tubes, the WGS catalyst may be provided in the shell side volume. For example, as a bed of formed catalyst particles (e.g. pellets). Alternatively, as a structured catalyst which may be in the form of metal or ceramic monoliths, or folded metal or ceramic structures, in each case coated with a water gas shift catalyst. Such structured catalysts are described for instance in WO2012/103432 and WO2013/151885 (Johnson Matthey) and are available commercially as CATACEL™ technology from Johnson Matthey.

In a preferred embodiment the tubes of the gas heated reformer are at least partially made of steel, a nickel-containing steel or a nickel-based alloy. As used herein the term “steel” refers to an iron-based alloy containing iron as the single largest component and also including carbon. Steels used in the manufacture of tubes for a gas heated reformer typically also contain nickel, i.e. are nickel-containing steels. Alternative materials for the tubes of the gas heated reformer include nickel-based alloys containing nickel as the single largest component, such as Inconel®. It is preferred that at least a portion of the outside surface of the tubes is made of steel, a nickel-containing steel or a nickel-based alloy. Nickel steels and nickel-based alloys are designed to minimise metal dusting reactions but can be expensive. A further benefit of the present invention is that it may expand the number of materials which can be used for the gas heated reformer tubes, and may allow less expensive materials to be used.

The gas heated reformer is typically a component of a plant which is used to produce syngas. The syngas may be used in downstream processes (e.g. for hydrogen, methanol or ammonia production). It will be appreciated that the extent of water gas shift on the shell side will be more targeted where the gas heated reformer is a component of a plant for producing methanol, as compared to in the situation where the gas heated reformer is a component of a plant for producing hydrogen or ammonia. In the latter cases, since the plant will typically include various steps downstream from the gas heated reformer to maximise hydrogen production, it is not so important to control the extent of WGS on the shell side.

The invention also relates to a plant for the production of hydrogen, ammonia or methanol, comprising a gas heated reformer according to the first aspect.

In a preferred embodiment the plant comprises a gas heated reformer and an autothermal reformer arranged in series, and arranged so that partially reformed gases from the autothermal reformer are fed to the shell-side of the gas heated reformer to provide heating for the reforming reactions taking place on the tube-side of the gas heated reformer.

### Process

The invention also relates to a steam reforming process carried out using the apparatus according to the first aspect.

The method of the present invention is of particular utility for catalytic steam reforming apparatus used for steam reforming of hydrocarbons. In a typical process a mixture comprising a hydrocarbon feedstock and steam, and in some cases also carbon dioxide or other components, is passed at an elevated pressure through catalyst-filled heat exchange tubes which are externally heated to a maximum temperature in the range 700° C. to 900° C. by means of a suitable heat exchange medium, generally a hot gas mixture, so as to form a primary reformed gas. Catalysts for carrying out primary reforming include shaped units, e.g. cylinders, rings, saddles, and cylinders having a plurality of through holes, and are typically formed from a refractory support material e.g. alumina, calcium aluminate cement, magnesia or zirconia impregnated with a suitable catalytically active material which is often nickel and/or ruthenium. An example of commercial reforming catalysts include KATALCOT steam reforming catalysts from Johnson Matthey. Structured catalysts may also be used in the reformer tubes.

The hydrocarbon feedstock may comprise any gaseous or low boiling hydrocarbon feedstock such as natural gas. It is preferably methane or natural gas containing a substantial proportion of methane, e.g. over 90% v/v methane. The feedstock is preferably compressed to a pressure in the range 20-80 bar abs.

The method and apparatus of the present invention differ from a conventional heat exchange reformer apparatus in that a WGS catalyst is present on the shell side. As described previously, the role of the WGS catalyst is to reduce the concentration of CO on the shell side and thereby reduce or prevent metal dusting and methanation.

The heat exchange medium fed to the shell side is a synthesis gas, by which we mean a gas comprising CO and H₂. It is preferred that the heat exchange medium is the primary reformed gas (formed in the tubes of the gas heated reformer) that has been subjected to further processing, in which case it will also include steam, CO₂ and low levels of CH₄. In a preferred embodiment the heat exchange medium is the primary reformed gas exiting the process fluid off-take zone that has been subjected to a further processing step. The further processing step is typically partial combustion with an oxygen-containing gas, e.g. air, oxygen-enriched air, or oxygen. Preferably the partially combusted primary reformed gas is then passed through a bed of a secondary reforming catalyst, so as to effect further reforming (i.e. secondary reforming), before being used as the heat exchange medium.

It is preferred that the conversion of hydrocarbons is essentially complete before the reformed synthesis gas (heat exchange medium) is fed to the inlet of the shell side of the gas heated reformer. Typically the synthesis gas fed to the inlet of the shell side of the gas heated reformer has a methane content of less than 10 vol %, preferably less than 5 vol %, for example less than 2 vol %.

The reformed synthesis gas (heat exchange medium) is fed to the inlet of the shell side of the gas heated reformer. Typically the gas entering the inlet has a temperature of 700° C. or more.

The pressure of the heat exchange medium fed to the inlet of the shell side is typically 20-80 bar abs., preferably 20-55 bar abs., more preferably 20-45 bar abs.

The heat exchange medium is contacted on the shell side with a WGS catalyst in order to convert CO and steam present in the heat exchange medium into CO₂ and H₂. The heat exchange medium at the outlet from the shell side has a decreased concentration of CO compared to the heat exchange medium at the input to the shell side.

The outlet from the shell side may require further downstream processing to achieve an acceptable yield of H₂. Typically a WGS unit is present downstream from the shell side outlet. The skilled person will be aware of the design of suitable WGS units.

The outlet from the shell side, optionally having undergone further reactions to increase H₂ yield, may be treated downstream to remove contaminants (CO₂, hydrocarbons etc.).

### Retrofitting Method

An advantage of the present invention is that a WGS catalyst can be retrofitted into the shell side of existing reforming apparatus during reactor downtime. The existing apparatus comprises one or more tubes and a shell surrounding the tube(s) and together with the tube(s) defining a shell side, wherein the shell comprises an inlet and outlet for a heat exchange medium.

The method comprises a step of providing the shell side with a water gas shift catalyst. The resulting reformer may be as described in the first aspect. The arrangement and type of water gas shift catalyst may be as described under the “gas heated reformer” heading. Features described as being preferred under the “gas heated reformer” heading also apply to the retrofitted apparatus.

In one embodiment the method involves applying a coating of water gas shift catalyst on one or more of the existing tubes. A benefit of this method is that it does not require replacement of the reformer tubes and is a relatively cost-effective way of upgrading an existing reformer.

In one embodiment the method involves replacing one or more of the tubes with a tube having a water gas shift catalyst applied on its outer surface. This may be appropriate where the tubes are nearing the end of their service life and need replacing.

### DESCRIPTION OF THE FIGURES

The invention will further be described with reference to FIG. 1, which depicts a process flowsheet incorporating one embodiment of the present invention.

Referring to FIG. 1, natural gas at an elevated pressure, typically in the range 15 to 50 bar abs., is fed via line 10 and mixed with a small amount of a hydrogen-containing gas fed via line 12. The mixture is then heated in heat exchanger 14 and fed to a desulphurisation stage 16 wherein the gas mixture is contacted with a bed of a hydro-desulphurisation catalyst, such as nickel or cobalt molybdate, and an absorbent, such as zinc oxide, for hydrogen sulphide formed by the hydro-desulphurisation. The desulphurised gas mixture is then fed, via line 18, to a saturator 20, wherein the gas contacts a stream of heated water supplied via line 22. The saturated gas leaves the saturator via line 24 and may if desired be subjected to a step of low temperature adiabatic reforming. The saturated gas may if desired be mixed with recycled carbon dioxide supplied via line 26 and then heated in heat exchanger 28 to the desired heat exchange reformer inlet temperature. The heated process gas is then fed, via line 30, to the catalyst-containing tubes of a heat exchange reformer 32. The heat exchange reformer has a process fluid feed zone 34, a heat exchange zone 36, a process fluid off-take zone 38 and first 40 and second 42 boundary means separating said zones from one another. The process fluid is subjected to steam reforming in a plurality of heat exchange tubes 44 containing a steam reforming catalyst to give a primary reformed gas stream. Only 4 tubes are shown; it will be well understood by those skilled in the art that in practice there may be 10's or 100's of such tubes. The primary reformed gas stream is then passed from said heat exchange tubes 44 to the process fluid off-take zone 38, and thence via line 46 to further processing. The further processing comprises partial combustion with an oxygen-containing gas, supplied via line 48, in a vessel containing a bed of secondary reforming catalyst 50, for example nickel supported on calcium aluminate or alumina. The resultant secondary reformed gas is passed via line 52 to heat exchange zone 36 as the heat exchange medium. The heat exchange medium passes up through the spaces between the heat-exchange tubes thereby supplying the heat required for the primary reforming. A water gas shift catalyst 37 is included in the heat exchange zone to carry out water gas shift reactions. The shifted gas exits the reactor via line 56.

FIG. 2 shows the exit concentrations of CO, CO₂ and CH₄ produced in Comparative Example 1.

FIG. 3 shows the exit concentrations of CO, CO₂ and CH₄ produced in Example 2.

### EXAMPLES

### Example 1 (Comparative)

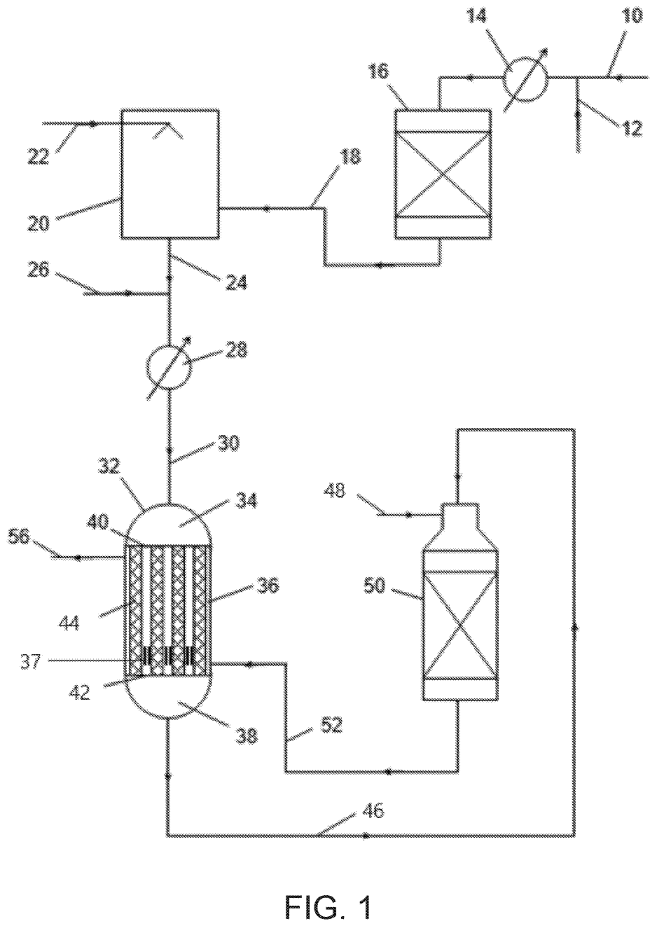

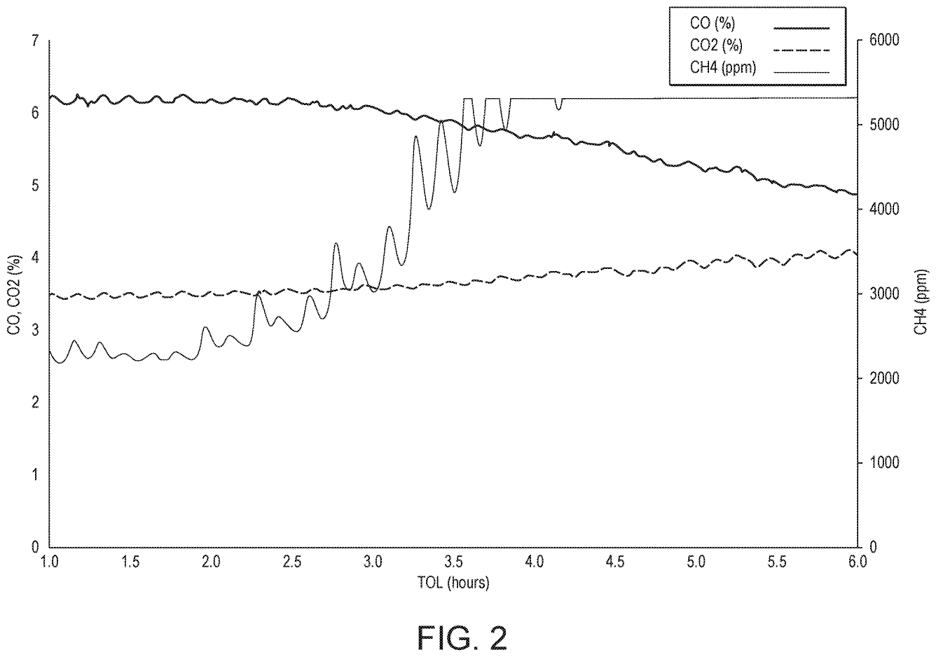

A rod of Incoloy® 800HT®, a Ni—Fe—Cr alloy containing C, Al and Ti additions, with diameter 3 mm was cut into semi-circular pieces and placed within a reactor vessel. In total 73 pellets were loaded into the reactor with a total mass of 10.9 g and surface area of ˜2400 mm². A 24-hour pre-treatment in H₂ at 615° C. was carried out prior to introducing process gas to remove any protective oxide layer from the material surface, thus accelerating time taken to initiate metal dusting. A process gas having the composition shown in Table 1 was introduced into the reactor. The exit concentrations of CO, CO₂ and CH₄ were measured and are shown in FIG. 2. The exit concentration of methane increased steadily over the course of the experiment.

TABLE 1

| Component | Mol % |
|---|---|
| CO | 5.8 |
| CO₂ | 3.6 |
| CH₄ | 0.2 |
| H₂ | 69.7 |
| N₂ | 1.1 |
| H₂O | 19.6 |

### Example 2

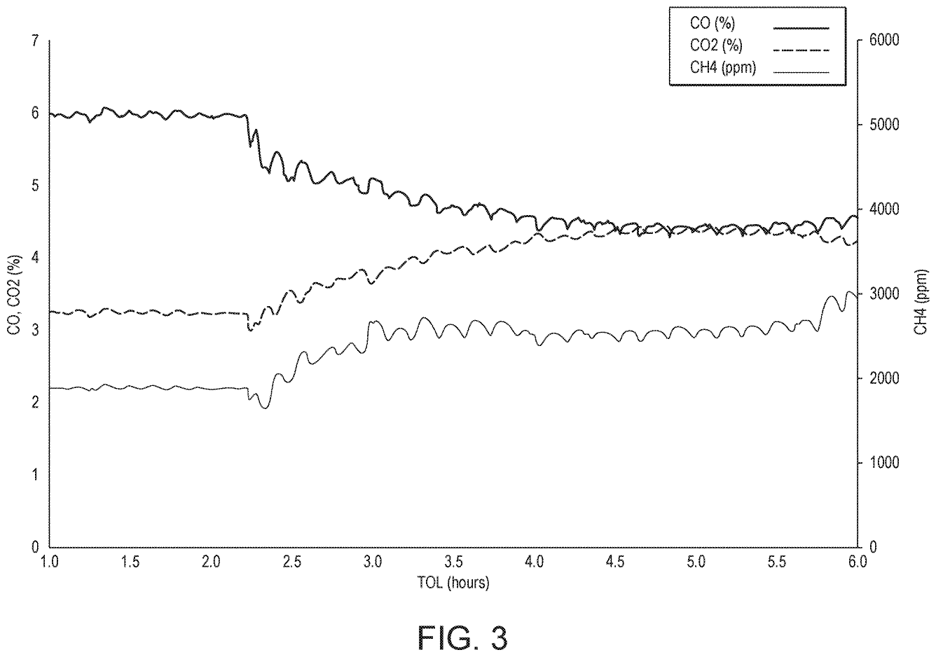

The procedure of Example 1 was followed except that the Incoloy® 800HT® rod was replaced with an Incoloy® 800HT® rod that after cutting into semi-circular pieces had been coated with a CATACEL™ material (water gas shift catalyst) from Johnson Matthey. The exit concentrations of CO, CO₂ and CH₄ were measured and are shown in FIG. 3. The exit concentration of methane remained low over the course of the experiment.

1. A gas heated reformer apparatus comprising:
one or more tubes containing a steam reforming catalyst; and
a shell surrounding said tube(s) and together with the tube(s) defining a shell side;
wherein the shell comprises an inlet and outlet for a heat exchange medium;
wherein the shell side is provided with a water gas shift catalyst located at one or more areas of the shell side where during use the heat exchange medium in contact with the shell side has a temperature of 500-750° C.

2. An apparatus according to claim 1, wherein the water gas shift catalyst is only located at areas of the shell side where during use the heat exchange medium in contact with the shell side has a temperature of 500-750° C.

3. An apparatus according to claim 1, wherein the steam reforming catalyst is located within the tube side volume.

4. An apparatus according to claim 3, wherein the tube side volume includes one or more catalyst beds comprising a steam reforming catalyst.

5. An apparatus according to claim 3, wherein the tube side volume includes one or more structures coated with a steam reforming catalyst.

6. An apparatus according to claim 1, wherein the tube(s) are at least partially made of steel, a nickel-containing steel or a nickel-based alloy.

7. An apparatus according to claim 1, wherein the water gas shift catalyst is provided as a coating on the outer surface of the tube(s).

8. A plant for the production of hydrogen, ammonia or methanol, comprising a gas heated reformer apparatus according to claim 1.

9. A plant according to claim 8, comprising a gas heated reformer and autothermal reformer arranged in series, and arranged so that partially reformed gases from the autothermal reformer are fed to the shell-side of the gas heated reformer to provide heating for the reforming reactions taking place on the tube-side of the gas-heated reformer.

10. A steam reforming process carried out in a heat exchange reformer apparatus according to claim 1, comprising the steps of:
providing a heat exchange medium comprising a synthesis gas to the inlet of the shell side; and
carrying out water gas shift on the shell side.

11. A process according to claim 10, wherein the synthesis gas fed to the inlet of the shell side has a methane content of less than 10 vol %.

12. A process according to claim 10, wherein the synthesis gas fed to the inlet of the shell side has a methane content of less than 5 vol %.

13. A process as claimed in claim 10, wherein the temperature of the heat exchange medium fed to the inlet of the shell side is 700° C. or more.

14. A process as claimed in claim 10, wherein the pressure of the heat exchange medium fed to the inlet is 20-80 bar abs.

15. A process as claimed in claim 10, wherein the pressure of the heat exchange medium fed to the inlet is 20-55 bar abs.

16. A method of retrofitting a gas-heated reformer apparatus, the apparatus comprising:
one or more tubes and a shell surrounding the tube(s) and together with the tube(s) defining a shell side, wherein the shell comprises an inlet and outlet for a heat exchange medium;
the method comprising the step of providing the shell side with a water gas shift catalyst located at one or more areas of the shell side where during use the heat exchange medium in contact with the shell side has a temperature of 500-750° C.

17. A method according to claim 16, wherein the step of applying a water gas shift catalyst to the shell side of the reformer involves applying a coating of water gas shift catalyst on one or more of the existing tubes.

18. A method according to claim 17, wherein the tubes are at least partially made of steel.

19. A method according to claim 16, wherein the step of applying a water gas shift catalyst to the shell side of the reformer involves replacing one or more of the tubes with a tube having a water gas shift catalyst applied on its outer surface.

20. (canceled)
